(19) United States
(12) Patent Application Publication
(10) Pub. No.: US 2013/0276008 A1
(43) Pub. Date: Oct. 17, 2013

(54) Content Based Advertising

(71) Applicants: Ping WU, Saratoga, CA (US); Jun Peng, San Ramon, CA (US)

(72) Inventors: Ping WU, Saratoga, CA (US); Jun Peng, San Ramon, CA (US)

(73) Assignee: Google Inc., Mountain View, CA (US)

(21) Appl. No.: 13/445,789

(22) Filed: Apr. 12, 2012

(51) Int. Cl. H04N 21/458; H04N 21/643; H04N 21/442

(52) U.S. Cl. 725/14; 725/34; 725/109

(57) ABSTRACT

A method, and a corresponding system, provide advertisements relevant to media displayable on a first electronic media display device. The method includes providing one or more content tags in the displayable media; receiving a signal originating from the first electronic media display device indicating detection of a content tag; selecting an advertisement based on the received content tag detection signal; sending the selected advertisement and one or more selectable action items, the selectable action items associated with the advertisement; receiving an action item selection; and responding to the action item selection.

### BACKGROUND

Digital television programming offers many opportunities for advertising products and services. Current mechanisms to exploit these opportunities include banners and overlays shown during display of a television program, and program breaks during which advertisements are displayed. However, the displayed advertisements may not be relevant to the displayed television program.

### DESCRIPTION OF THE DRAWINGS

The detailed description will refer to the following figures in which like numerals refer to like items, and in which:

FIG. 1 illustrates an embodiment of a system that may provide advertisements relevant to media displayed on an electronic media display device;

FIG. 2 illustrates an embodiment of an environment that supports display of advertisements that may be relevant to media displayed on an electronic media display, device;

FIG. 3 illustrates hardware components of devices that provide and display advertisements that may be relevant to media displayed on an electronic media display device;

FIG. 4 illustrates an embodiment of, a software system that enables the provision and display of advertisements that may be relevant to media displayed on an electronic media display device; and

FIGS. 5-8 are flowcharts illustrating embodiments of methods for provision and display of advertisements that may be relevant to media displayed on an electronic media display device.

### DETAILED DESCRIPTION

Digital television programming offers many opportunities for advertising products and services. Current mechanisms to exploit these opportunities include banners and overlays shown during display of a television program, and program breaks during which advertisements may be displayed. However these mechanisms may not account for content in the displayed television program, and the displayed advertisements may not be relevant to the displayed television program.

Disclosed herein are a content-based advertising system, and a corresponding method, that achieves relevancy between media content and advertisements provided to viewers of the associated media by using content tags that may be added to the media and that identify specific “scenes” in the media. The content tags may serve as anchor points in a media stream. The anchor points may designate advertisement opportunities and monetizable features, such as specific scenes and product placements. The content tags may be provided at a time in advance of the display of the advertisement opportunities, or immediately preceding the advertisement opportunities. The content tags encode information that is processed by the device displaying the media. The processed information (i.e., processed content tags) provides a mechanism to deliver a specific advertisement, or action items related to a specific advertisement, to a media device, such as a tablet or smart phone that is being used by a viewer, of the media. For example, the display of the media on a first media device may lead to display of action items and/or an advertisement on a second media device. In an alternative, the advertisement may be displayed on the first media device and the action items on the second media device. In another alternative, the advertisement and the action items may be displayed on the first media device, and the second media device functions as a remote control device. In yet another alternative, the advertisement may be displayed on the second media device and the action items on a third media device. Other display alternatives are possible. The display of the advertisement and action items may be in real, time, or near real time (i.e., within minutes of display of the content-tagged scene), or may be delayed. The advertisement service providing the advertisement may delay delivery or may deliver the advertisement and action items in real time or near real time, and the media device receiving the advertisement and action items may save (buffer) each for later display to the viewer.

In an alternative, the delivery mechanism includes a “push notification” scheme in which the advertisements and/or the action times may be “pushed” to the viewer.

A content service may work in conjunction with a product manufacturer or service provider to identify and designate anchor points for launching an advertising request. The media stream may be encoded with content tags at one or more of the anchor points. An advertiser may associate advertisements with some or all of the content tags. When the media is displayed on a first media device, a processor in the first media device may, detect the content tag. Detection of the content tag may cause the processor to send an advertisement request to an advertisement service, which may be remote from the first media device. The advertisement service then may select an appropriate advertisement and send the selected advertisement, and, in addition, a menu or display of action items, to a second media device that may be independent of the first media device. Alternatively, the advertisement service, or another service linked, to or in communication with the advertisement services, send a push notification to the second media device. A viewer, or individual, operating the second media device may activate one or more of the action items, and such activation may cause the second media device to be directed to a location that displays further advertising information related to the content displayed at the anchor point.

Thus, a method for providing advertisements relevant to media displayable on an electronic media display device may include providing a content tag in the displayed media, receiving a selection of the content tag, the selection indicating detection of the content tag, selecting an advertisement based on the received content tag selection sending the selected advertisement and an action interface the interface, providing one or more selectable actions, the selectable actions associated with the advertisement, receiving an action item selection, and responding to the action item selection.

The content tags may be provided by the creator (e.g., a movie studio, a television studio—a content service) of a media, such as a movie or television program. The media for which advertisements based on content tags may be provided can include television programs, movies, including broadcast and pay-per-view movies, YouTube videos, and other content or forms of media. Hereafter, the detailed description generally will refer to such media as a movie. The content tags may be provided for each monetizable feature, or a subset of such features, in the movie. In the example of a car chase scene as a monetizable feature, the manufacturer of the vehicles involved in the chase may desire to associate an advertisement for their vehicles with the car chase scene, which is being watched on a first media device by an individual, and to push an advertisement for their vehicles to a second media device operated by, or being watched by, the same individual. When a car chase scene in a movie includes multiple vehicle brands, opportunities may arise for each of the vehicle manufacturers to associate an advertisement for their vehicles with the car chase scene.

The content service may negotiate, in advance of the creation of the movie, with product manufacturers or service providers to use specific products and services when filming the movie, and then provide content tags for scenes in which the specific products or services may be shown. Using the example of the car chase scene, the content service may negotiate with each of two manufacturers of high performance automobiles to use one of their automobiles in the car chase scene, and to emplace content tags in the movie during, or in the vicinity of the car chase scene. The manufacturers and their advertisers then may bid to have specific advertisements sent to individuals viewing the car chase scene, where an advertisement request is generated by the first media device (i.e., the media device displaying the car chase scene of the movie) and is sent to an advertisement service, and in return, an advertisement and action items may be sent to a second media device.

Alternately, the movie may be filmed with scenes showing generic products or services, such as an up-scale vacation resort on a tropical island, and owners of such resorts, travel services airlines, and similar entities involved in the tourist and vacation trade may bid to have advertisements for their services sent to the second media device when the movie scene showing the resort is displayed on the first media device.

In addition to scenes, such as a car chase, or waves coming ashore at a tropical beach, the movie may provide other locations where addition of a content tag would be appropriate. For example, a movie scene of a bar may show specific brands of beer being consumed by bar patrons. A content tag may, be provided for such “product placements,” and an advertisement linked to this product placement. Content tags also may be provided for generic products, such as a generic computer, bottle of wine, television, cologne bottle, or other consumer good or product available for purchase, for example.

Content tags may include information (e.g., content metadata) that may identify, or be used to identify, a specific scene in the movie. The content tags also may include an advertisement request address, such as an advertisement request url. A processor in the media device may detect and decode the content tag, and request an advertisement from the advertisement service.

Content tags may be implemented using one of several mechanisms. One such mechanism is a metadata file, similar to a subtitle file, that may be used to relate the media (movie) content at a specific anchor point to possible advertisements. More specifically, the metadata file form of a content tag may include information to identify the content such as a timeline and content metadata that unambiguously identifies the content at the anchor point. For example, the content metadata may identify the make of automobile in the car chase scene, the brand of beer in a bar scene, or display of a tropical beach and resort in a vacation scene. The metadata files then may be cross-referenced to, data stored, for example, with an advertisement service, where the stored data provides further information about the scene for use by advertisers in determining whether or not to bid for an advertisement to be associated with the content tag.

Other mechanisms to implement content tags include a 2-dimensional bar code embedded in the media stream. The barcode may be decoded by the processor incorporated into the media device. Similar to the barcode, an inter-frame digital fingerprint, which also may be decoded by the processor, may be used to identify the content.

Another mechanism involves storing a content identification in an existing, codec metadata field. Codecs have an internal feature for including metadata about a current media stream. This feature may be one of the codec headers, which is intended for short, text comments. These comments store metadata describing the stream in key=value pairs, such as “CAR=Porsche”, “MODEL=911.” Multiple copies of any given key may be allowed (for example, multiple “CAR” keys may be used).

Yet another content identification mechanism involves the media device passing the “name” or title of the media and other content metadata to a remote content service, and the content service returning a content identification. The media device adds a time-stamp, and returns the time-stamped content identification to the content service, which the content service uses to identify the specific scene from the displayed media.

Still other content identification mechanisms involve expanding existing WebM protocols to incorporate content tags, and defining a new video format to incorporate content tags.

While, as described above, detection and processing of the content tag may result in delivery, by the media device displaying the movie, of an advertisement request to an advertisement service and return of an advertisement to the media device, in addition, a set of action items also may be returned. In one embodiment, the action items may be provided as part of an action interface. The action interface may be returned to the media device displaying the movie. Alternately, the action interface may be returned to a second media device, independent of the media device displaying the movie. In either embodiment, the action interface may be used to initiate one of the actions provided for in the action interface.

In an example, the action interface contains and displays one or more interactive action icons, with each icon representing a possible action available to an individual, and the available actions may be related to, or relevant to, the associated returned advertisement and the identified content scene of the movie. In an alternative, an action icon contains a link or address (e.g., a url) to a Web site or other location associated with the advertised product or service and/or the products or services shown in the movie. For example, in a car chase scene involving a Porsche and a BMW, one action icon may take an individual to a Porsche Web site and a second action icon may take the individual to a BMW Web site. In this example, when the individual accesses one or both Web sites, a signal may be sent to the advertisement service and an impression may be recorded. Other examples of action icons may allow the individual to interact with a rich media advertisement, and for an individual who may be logged onto a social network or service, the individual may choose to “like” the served advertisement, and show that information on the social network.

The above-described advertisements based on content tags use, in an example, a first media device and a second media device independent of the first media device. The first media device may be an intelligent, Internet-connected television or a basic television that is connected to the Internet through a processor-based device such as a set top box or media access box. Both of these, television configurations will be referred to hereafter as iTVs. The second media device may be a device, such as a tablet, laptop or desktop computer, or smart phone that also may connect to the Internet. In some cases, the second media device also may receive content (e.g. movies) from the content provider. The second media device may include a mobile remote controller (MRC) application that enables the second media device to interact with the first media device using WiFi, for example. In operation, a processor in the iTV may detect a content tag during display of a movie, decode and record the content tag information, and send the decoded information and an advertisement request to a remote content service. The remote content service identifies the content and sends the advertisement request and the content identification to one or more advertisement services. An advertisement service selects an appropriate advertisement and returns the advertisement and the content identification to the iTV. The advertisement may be displayed immediately or the display may be delayed. The iTV may send the content identification to the second media device, which in turn may send the content identification and an identity of the second media device to the advertising server. The advertisement service then sends one or more of an advertisement and an action set to the second media device where action items in the action set, represented by interactive action icons, may be displayed in an action interface. In conjunction with displaying the returned advertisement, the mobile second media device may display the action interface, which may allow the individual operating the second media device to take one or more specific actions that may be relevant to the identified content and the returned advertisement.

Advertisers may bid on advertisements to be provided with specified content. For example, advertisers may bid for an inventory of advertising opportunities on a CPM (cost per thousand views) basis in which case, the advertiser works with the movie producer to arrive at a contract for a number of, impressions for certain objects or scenes in the movie. In the car chase example, an automobile manufacturer may want to show an advertisement about a new car model, perhaps one shown during the car chase scene. The advertiser representing the manufacturer may create an advertisement for the new car, model and load the advertisement on its own advertisement server. The advertiser then provides an index to the content service so that when an appropriate content tag is identified, the content provider's own server points to the advertiser server to select the new advertisement for delivery to the iTV. The advertisement service then may deliver the new advertisement, and the associated action set to the iTV. Alternately, the action set may be sent directly to the second media device (e.g., a tablet) from the advertisement service.

In an embodiment, rather than streaming, or otherwise delivering, advertisements and action items to the media devices in response to an advertisement request message, the content service prepares a combined movie/advertisement/action item package and delivers the package to a media device. The package includes the intended movie with its embedded content tags, but also includes a prepended file containing a number of, advertisements that may be relevant to some or all of the advertising opportunities (content tags). The prepended file further includes data and information needed to form the action icons and to complete the action interface for each interface supplied in the prepended file. Alternately, the prepended file contains only the advertisements or only the action icon and action interface data and information. The media device stores the advertisements and the action icon/action interface data and information until a content tag is detected during display of the movie. The use of a prepended file to store advertisements and action icon/action interface data and information may allow the content service to update or otherwise change the advertisements in the prepended file each time the movie is purchased or rented for display on the media device.

When the advertisements are provided in advance of the movie, or with the movie in a prepended file, detection of the advertisement service may send a substitute advertisement to the media device to use in place of an advertisement in the prepended file. The display of a substitute advertisement may be signaled to the media device with the return of the content identification.

The display of an advertisement tied to a content-tagged movie scene on a first media device may be synchronized with display of the action interface on second media device through the use of a time stamp, that is supplied to both devices. Alternately, the first media device may signal the second media device when the first media device is displaying the advertisement. The second media device then may render and display the action interface.

The systems and methods disclosed herein may use information related to a specific individual or device. For example, an individual may register with an Internet service provider, a content provider, and advertiser, or similar service entity and may, at least initially, provide personally-identifiable information such as name and address. However, to protect the individual's privacy, the systems and methods may use other “anonymized” information, such as the IP address of a device, a user name provided by the individual, or, other anonymous information that sufficiently identifies the individual or device without compromising the individual's privacy. Furthermore, the systems and methods may provide for the individual to opt in or opt out of a specific aspect of the method at any time. For example, the individual may opt out of a method that collects advertisements watched information.

A media device may send, with the consent of the individual (e.g., via opt out opt in, or anonymization), identification (ID) information to the server that identifies the media device and or the user at the client. One aspect of sending the information includes a media device signing on with a service. In some cases, the device may automatically sign on using previously provided and stored credentials or other automatic information. Any personally-identifiable information that may be provided by the user is made anonymous in the system. The anonymized information may include cookies, user/device identifiers, or other abstractions of the user's actual identity.

The herein disclosed systems and methods for providing advertisements relevant to content being displayed to an individual may include a further opt out feature whereby the individual pays a premium for an advertisement-free version of the movie. That is, as an incentive to be served with specific advertisements and action interfaces, the individual may view movies and other programming at a reduced price.

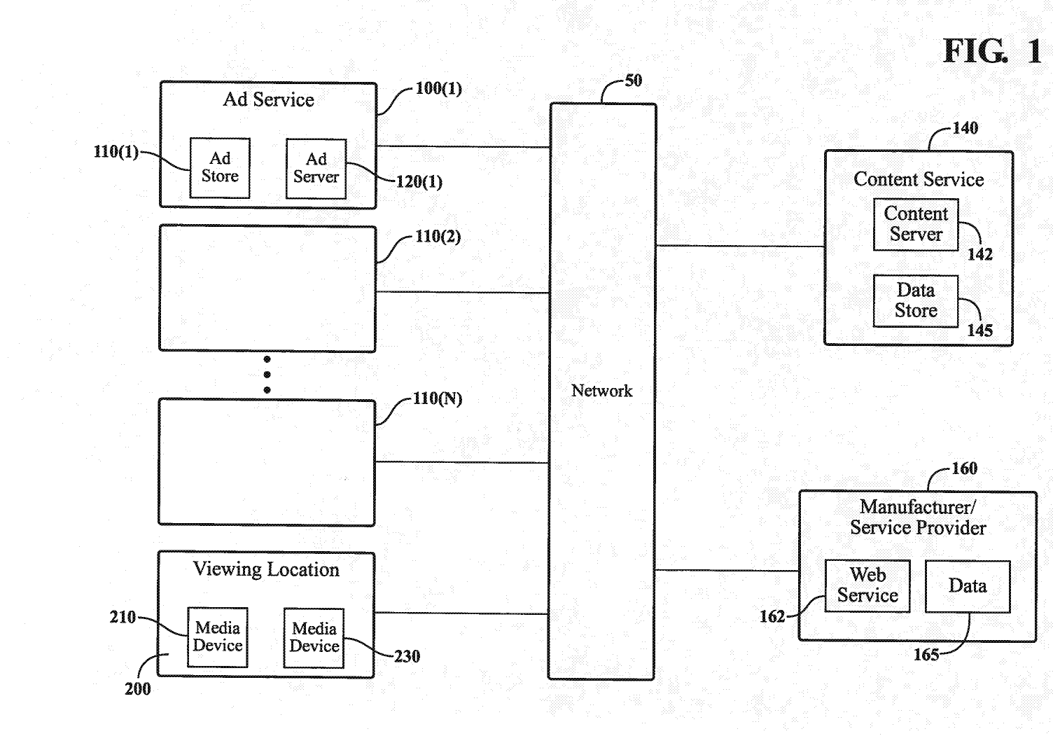

FIG. 1 illustrates an embodiment of a system that provides advertisements relevant to media displayed on an electronic media display device. In FIG. 1, system 10 includes advertisement services 100(1)-100(N), content service 140, manufacturers/service provider 160, and viewing location 200, all connected through network 50. The network 50 may be any communications network that allows the transmission of signals, media, messages, voice, and data among the advertisement services 100(i), content service 140, manufacturer/service provider 160, and the viewing location 200, including radio linear broadcast (over-the-air, cable, and satellite) television, on-demand channels, over-the-top media, including streaming video, movies, video clips, and games, text, email, and still images, and transmission of signals, media, messages, voice, and data. The network 50 may include the Internet, cellular systems, and other current and future mechanisms for transmission of these and other media. The network 50 may be both wired and wireless.

Each of the advertisement services 100(i) includes an advertisement store 110(i) and an advertisement server 120(i). The advertisement store 110(i) may store advertisements, data and information related to the advertisements, and computer programming to operate the advertisement servers 120(i) and the advertisement service 100(i). The advertisement services 100(i) may bid for advertisement slots in media supplied by the content service 140. The advertisement services 100(i) may cooperate with the manufacture/service provider 160 to develop advertisements for their products/services, and to store the advertisements in the advertisement stores 110(i).

The content service 140 includes content server 142 and content data store 145. The content service 140 owns content (e.g., movies) and may work with manufacturers and service providers to identify advertising, opportunities in the content (movies). Once the advertising opportunities are identified the content owners may provide content tags so that the advertising opportunities may be detected by computer programming executing on media display devices such as iTVs. The content owners also may negotiate with the advertisers to provide advertisements for the identified advertising opportunities.

The content server 142 operates to deliver content (movies) stored in content data store 145. The content server 142 may receive content tags from media devices at the viewing location 200 and determine and return a content identification to the viewing location 200. The content server 142 may cooperate with the advertiser servers 120(i) and the manufacturers/service providers 160 to develop a set of action items that may be presented to viewers of the movie. The content server 142 then may deliver the action items either to the advertiser servers 120(i) or directly to the media devices at the viewing location 200.

The content data store 145 stores content (movies), content scenes and content (product placement) locations with associated content identifications that may be used to uniquely identify content as provided by the received content tags, and content metadata received from the media devices at the viewing location 200.

The manufacturer/service provider 160 includes Web server 162 and data store 165. The Web server 162 may be used as an address for selected action items. The Web server 162 may pass impression data to the advertising services 100(i) and the content service 140. The data store 165 stores information related to visits to Web sites hosted by Web server 162, and computer programming to operate the manufacturer/service provider 160, including the Web server 162.

The viewing location 200 includes first media device 210 and second media device 230. The media devices 210, 230 at the viewing location 200 may receive content (movies) from the content service 140 and advertisements and action items from the advertising services 100(i). The media devices 210, 230 may provide content tags, time stamps, content metadata, and other information to the content service 140, and advertisement requests to the content service 140 and/or the advertisement services 100(i).

In an alternative the advertisements and action items are pushed to the media device 230. The media device 230 may include a push application. The push application receives a push notification from the advertisement server 120(1). The advertisement server 120(1) provides the push notification in response to an advertisement request from the media device 210. The push notification provides the viewer at the media device 230 the option to elect to receive the advertisement and/or the action items. If the viewer elects to receive these items, the push application signals the advertisement server 120(1), and the advertisement server 120(1) sends the advertisement and/or the action items.

In an alternative, the advertisement server 120(1) determines which of many second media devices (e.g., distinguishes media device 230 from numerous media devices) is to receive the advertisement and action items because the advertisement server 120(1), or a related service, maintains a mapping between first media devices and second (third, fourth) media devices. For example, in FIG. 1, the advertisement server 120(1) may maintain, or have access to, a mapping between the media devices 210 and 230, which shows the media devices 210 and 230 are commonly owned, or, alternately, are being viewed by the same viewer. To create such a mapping, the viewer may register each of the media devices 210 and 230 with an associated service. For example, the viewer may register the media devices 210 and 230 with the content service 140. The content service 140 then, with the consent of the viewer, may make this mapping available to the advertisement server 120(1). The registration may, be a one-time registration when the viewer first uses the media devices 210 and 230. The registration may occur each time the viewer turns on the media devices 210 and 230. The viewer may opt out of the mapping scheme at any time subsequent to registration. The registration may be used when the viewer owns only one of the media devices and is viewing another media devices which the viewer does not own. For example, the viewer may register a television in a hotel room with, a content service and register the viewer's own media device 230 with content service 140 to establish a mapping between two media devices that the viewer is using.

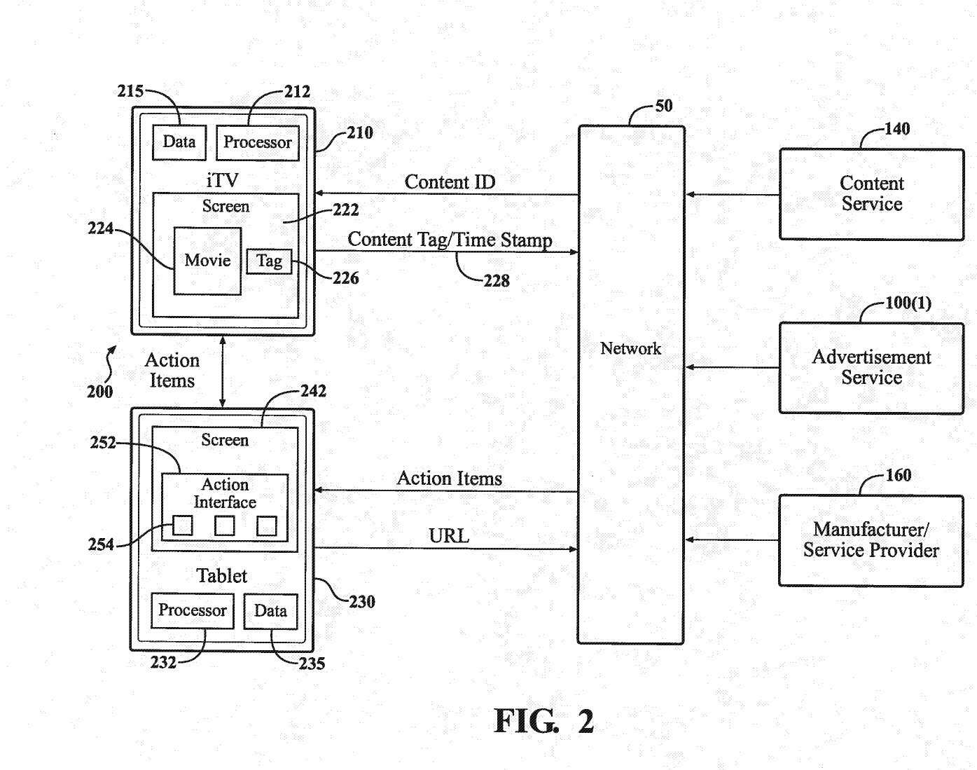

FIG. 2 illustrates an embodiment of an environment that supports display of advertisements that may be relevant to media displayed on an electronic media display device. In FIG. 2 the environment includes media devices at viewing location 200 in communication with content service 140, advertisement service 100(1) and manufacturer/service provider 160 through network 50. The media devices include iTV 210 and tablet 230.

The iTV 210 includes processor 212, data store 215, and display screen 222. Shown displayed on the screen 222 are content (i.e., movie) 224 and content tag 226. The tablet 230 includes processor 232, data store 235, and display screen 242. Shown displayed on the screen 242 is action interface 252 with action icons 254.

The iTV 210 receives content such as a pay-per-view movie, from content service 140. In exchange for a reduced price for the pay-per-view movie, or another incentive, the individual viewing the movie may agree to allow the periodic display of selected advertisements on the iTV 210. In addition, the individual may agree to receive action items related to the selected advertisements. The action items may be displayed on the screen 242 of the tablet 230. The individual may register the iTV 210 with a service such as the content service 140, and may register the tablet 230 with another service or with the content service 140. These services may maintain, or have access to, a mapping between the iTV 210 and the tablet 230 so as to provide advertisements and action items to the tablet 230 based on content displayed on the iTV 210.

The advertisements and action items may be provided by advertisement service 100(1) in cooperation with the content service 140 and the manufacturer/service provider 160. The action items may provide, for example, a link to a Web site operated by the manufacturer/service provider 160.

In operation, the iTV 210 displays movie 224, which has one or more advertising opportunities. The advertising opportunities may include specific content scenes such as a car chase scene or a couple strolling on a tropical beach, and product placements, such as a specific brand of beer in a bar. The advertising opportunities may be marked by content tags, such as content tag 226. During display of the movie 224, the processor 212 detects the content tag 224. The processor 212 extracts relevant information from the content tag 224, optionally adds time stamp data and other content metadata, formats the data into an advertisement request message 228, and sends the message 228 to the content service 140.

The content service 140 receives the message 228 and may decode the content tag data. The content service 140 may identify the associated content and retrieve a content identification for the content. The content service 140 may send the content identification to the iTV 210, and the advertisement request message 228, along with the content identification to the advertisement service 100(1).

The advertisement service 100(1) may select an advertisement appropriate for the content identification and sends the advertisement and the content identification to the iTV 210. In addition, the advertisement service 100(1) may send one or more action items and the content identification to the tablet 230. Alternately, the advertisement service 100(1) may provide a push notification to the tablet 230 and in return, may receive a signal from the tablet 230 before sending the action items to the tablet 230.

At a pre-selected time relative to receipt of the advertisement, and during display of the movie 224, the processor 212 may interrupt the movie 224 and display the advertisement. At the same time, the processor 212 may communicate with the tablet 230 to cause the action items to be displayed on the screen. The pre-selected time may be immediately upon receipt of the advertisement, or, at a later time. Several such advertisements may be displayed at the iTV 210, and the order and timing of display may be established by the advertisement service 100(1) and the content service 140 based on the content identification.

As an alternative to interrupting the movie 224 to display an advertisement, the movie 224 is not interrupted, and the advertisements are served to another media device, such as the tablet 230. In this alternative, the advertisement may be served so as to coincide with, or immediately proceed, the display of the action items on the tablet 230.

The tablet 230 may display the action items as action icons 254 in action interface 252. The display of the action interface 252 may be timed to coincide with display of the advertisement. Alternately, the processor 212 may signal the tablet 230 to display the action interface 252. The action icons 254 may be interactive, and when selected will initiate a specified action, such as connecting the tablet 230 with a Web site operated by the manufacturer/service provider 160.

The action taken by the tablet 230 in response to selection of a specific action icon 254 may be reported to the advertisement service 100(1). For example, connection to the Web site of the manufacturer/service provider 160 may be reported to the advertisement service 100(1), and may be recorded by the advertisement service 100(1) as an impression.

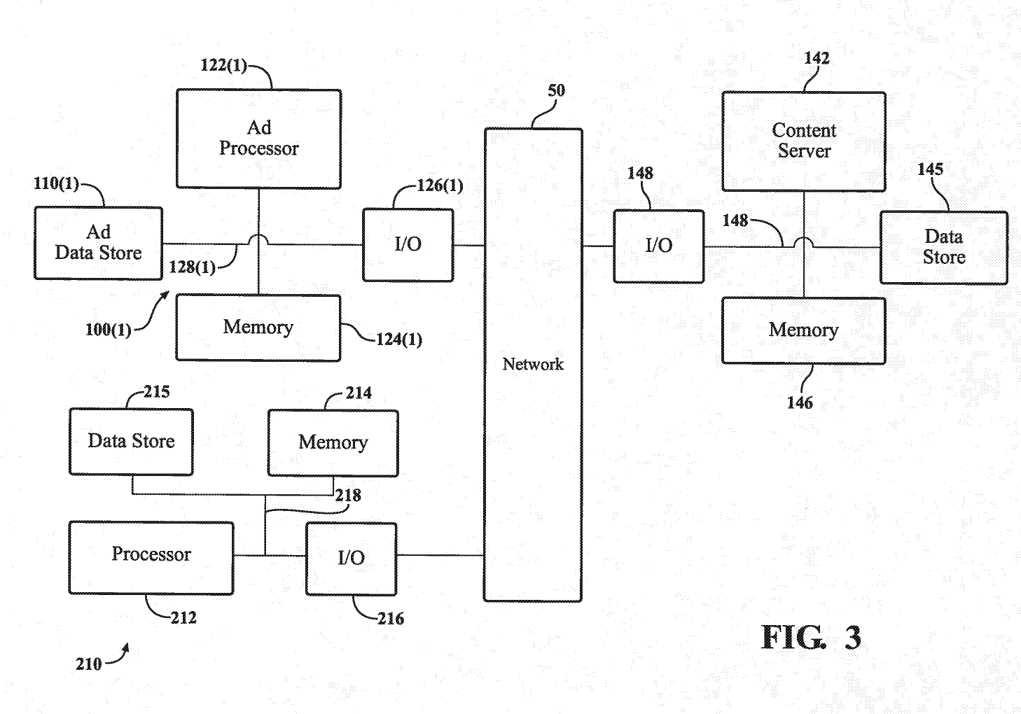

FIG. 3 illustrates hardware components of devices that provide and display advertisements that may be relevant to media displayed on an electronic media display device. In FIG. 3, the hardware components include those associated with advertisement service 100(1), content service 140, and iTV 210. The advertisement service 100(1) includes advertisement store 110(1), processor 122(1), memory 124(1), communications interface 126(1), and system bus 128(1). The advertisement store 110(1) stores advertisements, advertisement metadata, advertisement targeting criteria, and other data, and stores computer programming code (i.e., machine readable instructions) that is loaded into memory 124(1) to be read and executed by processor 122(1).

The content service 140 includes content server 142, content data store 145, content memory 144, communications interface 146, and system bus 148. The content data store 145 stores content (e.g., movies), content metadata, content tag identification information, and computer programming code that is loaded into memory 144 to operate the content service, and in particular the content server 142.

The iTV 210 includes processor 212, memory 214, data store 215, communications interface 216, and system bus 218. The data store 215 stores advertisements, content identifications, and other data, and stores computer programming code that is loaded into memory 214 to be read and executed by processor 212.

Although not shown in FIG. 3, the tablet 230 contains hardware components similar to those of the iTV 210.

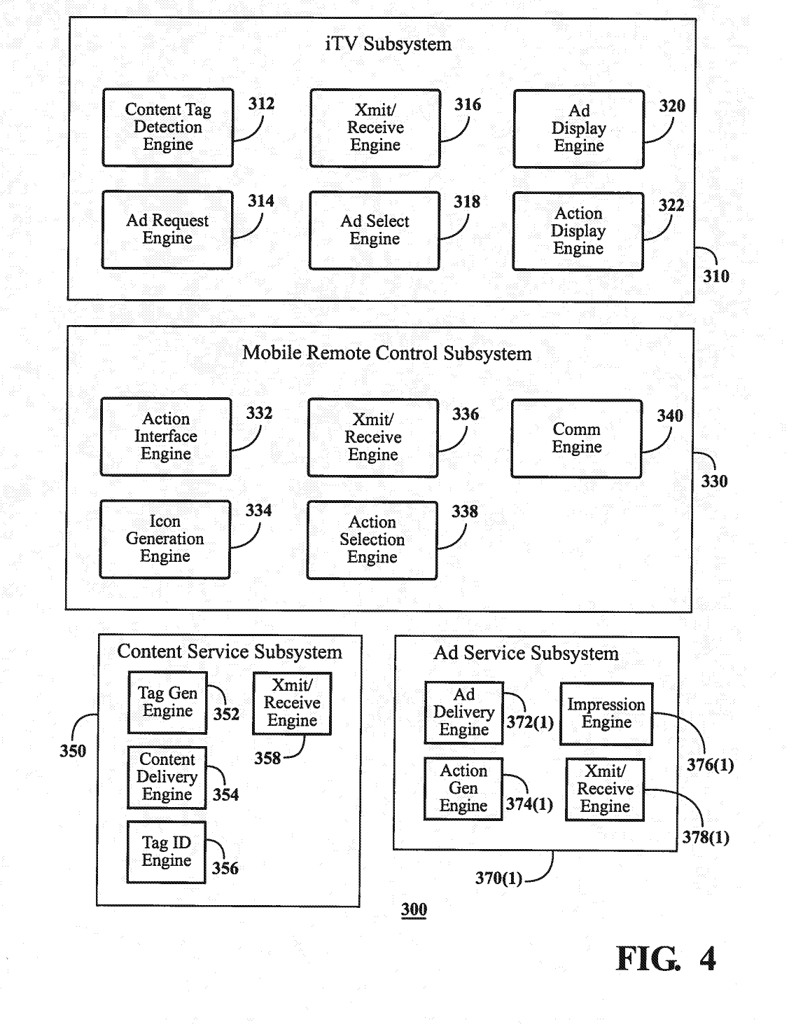

FIG. 4 illustrates an embodiment of a software system that enables the provision, delivery, and display of advertisements that may be relevant to media displayed on an electronic media display device such as the iTV 210, and an action interface on the tablet 230, both of which are shown in FIG. 2. In FIG. 4, software system 300 includes iTV subsystem 310 deployed on the iTV 210, mobile remote control subsystem 330 deployed on the tablet 230, content service subsystem 350 deployed on the content service 140, and advertisement service subsystem 370(1) deployed on the advertisement service 100(1).

The iTV subsystem 310 includes content tag detection engine 312, advertisement request engine 314, and transmit/receive engine 316, advertisement selection, engine 318, advertisement display engine 320, and action display engine 322. When the iTV 210 is displaying media with embedded content tags, which represent advertising opportunities, computer programming code of the iTV subsystem 310, normally stored in the data store 215 and subsequently copied to memory 214, is executed to detect the content tag, extract relevant information from the content tag, identify other information such as a time stamp, and incorporate the information into an advertisement request message that is sent to the content service 140.

The detection engine 312 may detect the presence of a content tag in a media stream, such as a movie. The detection engine 312 reads code forming the movie, and may determine when the code changes to indicate the presence of an advertising opportunity. The detection engine 312 also may note a time and date of display corresponding to the content tag, as well as other data and metadata, and provide the same to advertisement request engine 314, which may construct an advertisement request message to be sent to the content service 140. The transmit/receive engine 316 may transmit the advertisement request message to the content service 140, and in return, the transmit/receive engine 314 may receive a content identification message containing, the identification of the advertising opportunity as marked by the content tag. The transmit/receive engine 316 also may receive an advertisement to, be displayed on the iTV 210. The advertisement display engine 320 then may display the advertisement at a pre determined time, including immediately upon receipt of the advertisement, or at some time subsequent to receipt of the advertisement.

Alternately, the advertisements may be provided as an initial file of a purchased movie (i.e., as part of a prepended file of several advertisements that may be relevant to the purchased movie and its advertising opportunities), and the file may be stored in the data store 215 for subsequent display of one or more advertisements. In this alternative, the advertisement service 100(1) sends an advertisement selection signal to the iTV 210 instructing the iTV 210 as to which advertisement in the prepended file to display. In yet another alternative the iTV 210 receives back from the content service 140 only the content identification, and the advertisement selection engine 318 uses the content identification to select an advertisement from the prepended file that is most appropriate for the identified content, or advertising opportunity. Even if an initial advertisement file is prepended to a purchased movie, the content service 140 and advertisement service 100(1) may send an advertisement to the iTV 210 in response to the advertisement request message to use in place of any advertisements in the data store 215. When the advertisement selection engine 318 selects an advertisement for display on the iTV 210, the advertisement display engine 320 may render the advertisement and display the advertisement at a predetermined time.

The action display engine 322 generates a signal (e.g., a WiFi signal) that is sent to the tablet 230 providing the tablet 230 with the time of display of the advertisement and instructing the tablet 230 to render and display the action interface. In one alternative, all data and information related to rendering and displaying the advertisement and the action items may be sent to the iTV 210, or some part of the data and information may be sent to the iTV 210 in a prepended file. Part of, the prepended file may be a selection of action items and data required to complete rendering of the action icons and the action interface. Alternately the action icon and action interface data and information may be sent by the content service 140 or the advertisement service 100(1) directly to the tablet 230 and stored therein. If the data and information for the action icons and the action interface are sent to the iTV 210, the iTV 210 may provide this data and information to the tablet 230 as soon as the processor 212 reads the prepended file. Alternately, the iTV 210 may send data and information relevant only to the advertisement to be rendered and displayed after the iTV 210 receives the content identification from the content service 140 and either selects the advertisement from its own data store 215, or receives an advertisement directly from the advertisement service 100(1). In another alternative, the content service 140 or advertisement service 100(1) may send a push notification to the tablet 230, and await an acknowledgment signal from the tablet 230 before sending the advertisement and the action items.

The mobile remote control subsystem 330 includes action interface engine 332, action icon generation engine 334, transmit/receive engine 336, action selection engine 338; and communications engine 340. The transmit/receive engine 336 receives and decodes messages received over the network 50 including messages providing content identifications and action icon data and information. The action interface engine 332 renders and displays the action interface on the screen 242 of the tablet 230. The action interface engine 332 also receives the push notification, if implemented, and renders and displays a push notification window on the screen of the tablet 230. The action interface engine 332 then receives the individual's selection and returns a signal to the service that originated the push notification. The action icon generation engine 234 renders and displays action icons within the action interface. The action icons may be active in the sense that selection of an action icon will begin execution of an action such as following a url link to a manufacturer's Web page. The action selection engine 338 may be used to select an action icon and to initiate execution of the underlying action. The communications engine 340 may be used to communicate (e.g., by WiFi) with the iTV 210.

In the content service 140, content service subsystem 350 includes content tag generation engine 352, content delivery engine 354, content tag identification engine 356, and transmit/receive engine 358. The content tag generation engine 352 produces content tags and embeds or appends the tags to media such as a pay-per-view movie. The content tags may indicate advertising opportunity anchor points within the movie, such as the beginning “frame” of a car chase scene, or a frame displaying a specific product (i.e., product placement). The content delivery engine 354 sends the movie with its embedded content tags, and optionally with prepended advertisements and action items, to the iTV 210. The content identification engine 356 analyzes the received content tag, time stamp, and other data from the iTV 210, and may determine the content identification associated with the content tag. The content identification then may be used to determine which advertisement(s) to display on the iTV 210 and which action items to send to the tablet 230. That is, each content identification may have defined or listed, a number of advertisements that may be displayed. These advertisements may change over time, and may be updated by the content service 140 in cooperation with the advertisement service 100(1) and the manufacturer/service provider 160. When the advertisements change, the associated action items also may change. The transmit/receive engine 358 enables communications among the content service 140, the advertisement service 100(1), and the manufacturer/service provider 160, and between the content service 140 and the media devices at the viewing location 200.

In the advertisement service 100(1), advertisement service subsystem 370(1) includes advertisement delivery engine 372(1), action generation engine 374(1), impression engine 376(1) and transmit/receive engine 378(1). The advertisement delivery engine 372(1), in an embodiment, delivers one or more advertisements to the iTV 210 in response to an advertisement request message from the iTV 210. The advertisements may be delivered even in an environment where advertisements may be prepended to the delivered media. When the advertisements are to be, prepended to the delivered movie, the advertisement delivery engine 372(1) may deliver the advertisements to the content service for packaging with the movie. Alternately, a file of packaged advertisements may be sent directly from the advertisement service 100(1) to the iTV 210, as directed by the content service 140, and the packaged advertisements are stored in the data store 215 awaiting advertisement selection by the processor 212 executing the computer code of the iTV subsystem 310, specifically the advertisement selection engine 318. When a push notification is implemented, the advertisement delivery engine 372(1) may generate and send the push notification.

The action generation engine 374(1) may assign specific actions to coincide with specific advertisements, based on inputs from the manufacturer/service provider. The action generation engine 374(1) then may send the actions, as distinct code blocks, to either the iTV 210 or the tablet 230.

The impression engine 376(1) may receive a signal indicative of the tablet 230 initiating execution of one or more of the assigned actions, and may record the signal as an impression. The recorded impressions subsequently may be used by the content service 140, advertisement service 100(1), and manufacturer/service provider 160 for various economic and forecasting processes. Finally, the transmit/receive engine 378(1) allows the advertisement service 100(1) to send and receive messages over the network 50.

In some embodiments of the system 300, one or more engines or modules may be omitted or combined, or other modules or engines may be included.

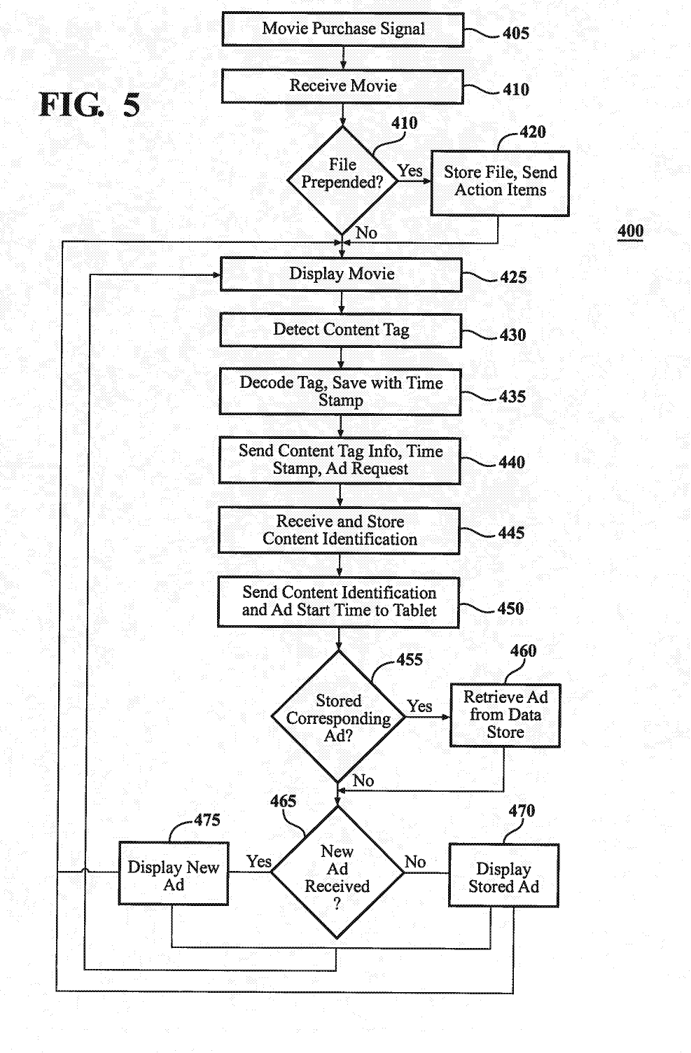

FIGS. 5-8 are flowcharts illustrating embodiments of methods for provision and display of advertisements that may be relevant to media displayed on an electronic media display device. In FIG. 5, method 400 begins with the iTV 210 and tablet 230 on, registered, and receiving programming at the viewing location 200 over the network 50 from content service 140. In block 405, the iTV 210 sends a signal to the content service 140 to purchase a pay-per-view movie at a discounted price, and in return to receive and display advertisements at the iTV 210 during display of the movie. In block 410, the iTV 210 receives the movie and in block 415, the processor 212 determines if the movie includes a prepended file containing advertisements and action items. If the prepended file is included, the method 400 moves to block 420 and the processor 212 stores the advertisements in the data store 215 and sends the action items to the tablet 230. The method 400 then moves to block 425. If, in block 415, a prepended file is not included, the method moves to block 425.

In block 425, the processor 212 begins display of the movie. In block 430, the processor detects a content tag. In block 435, the processor 212 decodes the content tag to determine content metadata and saves the content metadata along with a time stamp corresponding to the content tag. For example, the content metadata may indicate a car chase scene between a Porsche 911 Turbo Cabriolet and a BMW 645 convertible. Note that the content tag time stamp need not correspond to the start of the monetizable event. For example, the car chase scene may begin at time 20:00 (i.e., 20 minutes, zero seconds) after the start of the movie, but the content tag is provided at time 19:00 to provide a one minute delay between detection of the content tag and the actual start of the car chase scene. Alternately, the content tag may be provided at 20:00, or at a later time within the movie. Next, in block 440, the processor 212 sends the decoded content tag information time stamp, and other information such as an identification of the iTV 210 and tablet 230 (make, model, serial number) as part of an advertisement request message to the content service 140. Use of the content tag time stamp may obviate the need to prepend advertisements to the movie, or may allow the content service 140 to provide substitute advertisements for prepended advertisements.

In block 5, the processor 212 receives and stores the content identification corresponding to the content tag with instructions as to when the advertisement is to be displayed (e.g., at time 26:00, which is at the end of the car chase scene in the movie) from the content service 140. In block 450, the processor 212 sends the content identification and the advertisement start time to the tablet 230, and receives back an acknowledgment. In block 455, if advertisements were provided in a prepended file, the processor 212 determines if an advertisement is stored that corresponds to the content identification. If such an advertisement is stored in the data store 215, in block 460, the processor 212 prepares to display the stored advertisement at the designated time. The method then moves to block 465. If an advertisement corresponding to the content identification is not stored in the data store, the method 400 moves to block 465. In block 465, the processor 212 either receives or within a designated period, does not receive, an advertisement indexed to the content identification, from the advertisement service 100(1). If a substitute advertisement is provided, the advertisement service 100(1) includes instructions to replace an existing, stored advertisement, as appropriate. If a substitute advertisement is not received, the method 400 moves to block 470. In block 470, the processor 212, at the designated time, displays the advertisement selected from the data store 215. If a substitute advertisement is received, the method 400 moves to block 475. In block 475, the processor 212, at the designated time, displays the substitute advertisement. Following either block 470 or 475, the method 400 returns to block 425.

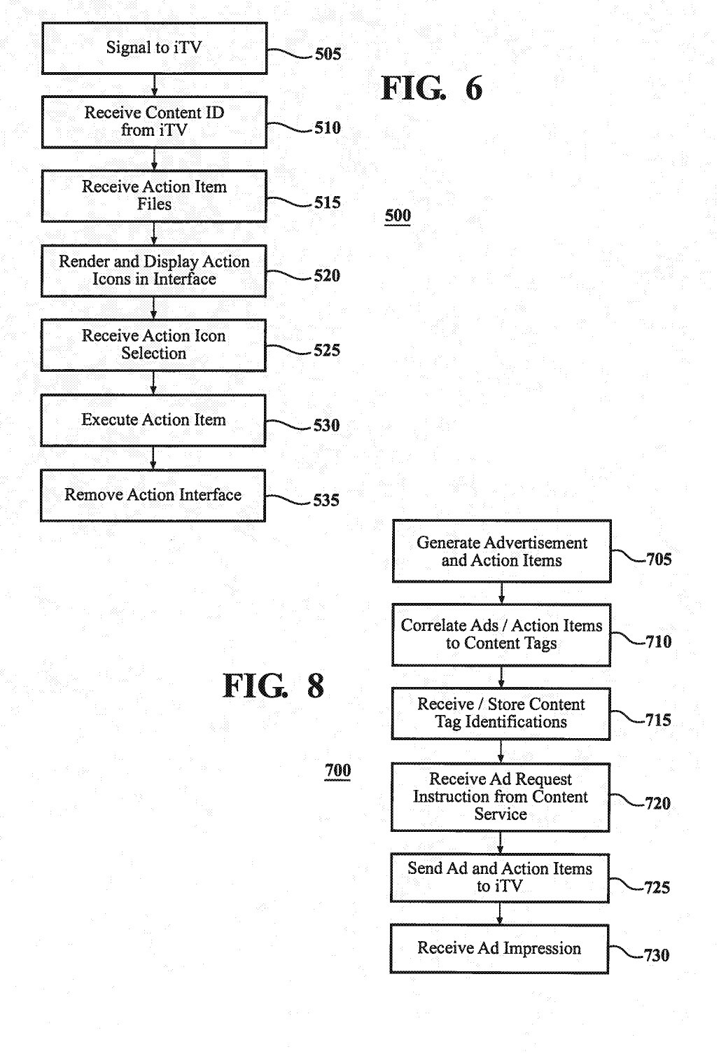

The flowchart of FIG. 6 illustrates an embodiment of a method for, displaying action items at the tablet 230 in synchronization with display of the movie and advertisement(s) at the iTV 210. Method 500 begins in block 505 when the processor 232 signals the iTV 210 that the tablet 230 is on and able to receive content over the network 50 and provides an identification of the tablet 230 to the iTV 210.

In block 510, the processor 232 receives the content tag identifications from the iTV 210, and stores the identification in the tablet data store 235. In block 515, the tablet 230 receives the action item files from either the iTV 210 or the advertisement service 100(1) and stores the files in the data store 235. In block 520, either in response to a direct signal from the iTV 210, or based on a time-stamp synchronization, the processor 232 renders and displays the action interface 252 and the action icons 254. In block 525, the processor 232 receives an action item selection, and in block 530, executes the action item. For example, in block 525, the processor 232 may sense a selection of a Web site icon, and in response, in block 530 access the Web site. In block 535, the processor 232 removes the action icons and action interface from display on the tablet 230, and the method 50 ends.

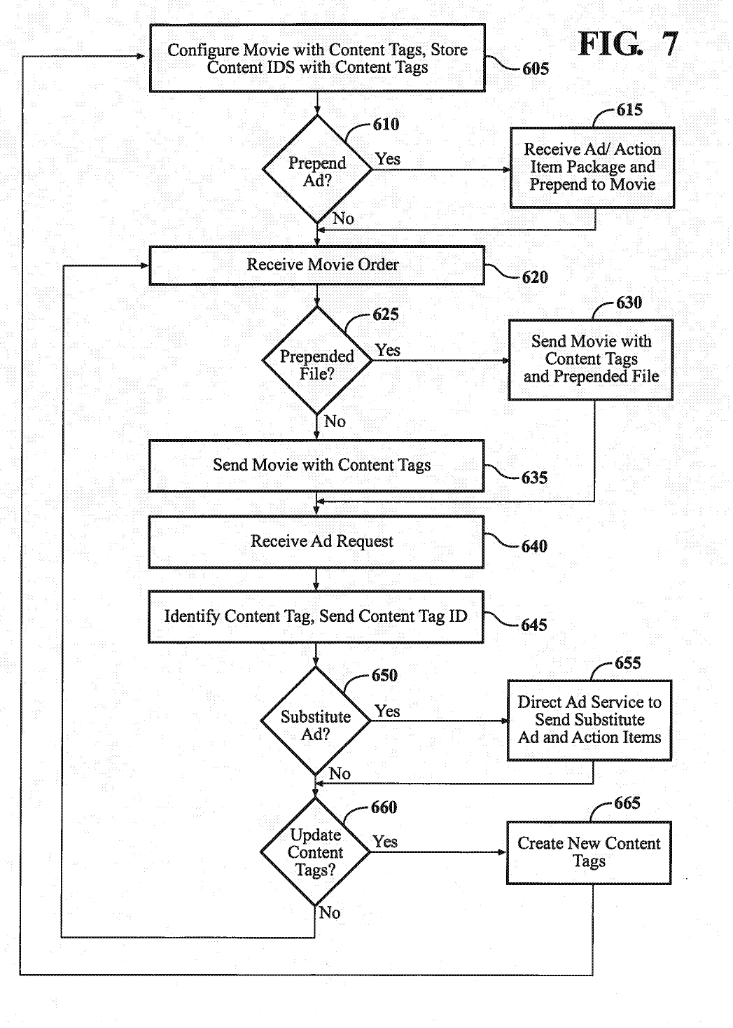

FIG. 7 is a flowchart illustrating an embodiment of a method for basing advertisements on the content in which the advertisements are to be displayed. In FIG. 7, method 600 begins in block 605 when the movie is configured with content tags for one or more monetizable features. A file identifying the movie, its monetizable features, identifications for each such monetizable feature, and other information may be compiled and stored in the content data store 145. In block 610, the content provider decides whether to prepend advertisements and action items to the movie. If the content provider decides to prepend advertisements and action, items, the method 600 moves to block 615, and the content service 140 receives a package of advertisements and action items from the advertisement service 100(1). The content service 140 then adds the content identifications to the package, and prepends the package to the movie. Prepending the advertisements and action items to the movie, in some situations, may obviate the need to recover a time stamp from the iTV. That is, the advertisements in the prepended file may be identified by the content tag identification, and the processor 212 in the iTV 210 may retrieve and render the appropriate advertisements, with or without a designated time delay, when the processor 212 detects the content tag. Alternatively, the prepended file may include “default” advertisements that will be displayed on the iTV when a content tag is detected unless a substitute or override, advertisement is supplied by the advertisement service 100(1) in response to the advertisement request sent by the iTV 210. Following block 615, and if there is no prepended file, following block 610, the method 600 moves to block 620.

In block 620, the content service 140 receives a movie order. In block 625, the content server 142 determines if the ordered movie includes a prepended advertisement file. If the movie does include the prepended advertisement file, the method 600 moves to block 630 and the content service 140 sends the movie with the prepended file to the iTV 210. In block 625, if a prepended file is not to be included with the movie, the content service provides the movie with the embedded content tags. Following either block 630 or 635, the method 600 moves to block 640.

In block 640, the content service 140 receives an advertisement request from the iTV 210. In block 645, the content server 142 determines the correct content identification based on the information contained in the advertisement request, and sends the content identification to the advertisement service 100(1), the iTV 210, and optionally to the tablet 230

In response to the advertisement request, the content server 142 also determines if, in the situation where the movie was supplied with a prepended advertisement file, a substitute or override advertisement is to be provided to the iTV 210 to replace one of the stored advertisements. If a substitute advertisement is to be provided, the method 600 moves to block 655, and the content server 142 directs the advertisement service 100(1) to select and send the substitute advertisement, and associated action item file, to the iTV 210. If in block 650, a substitute advertisement is not to be sent, and following block 655, the method 600 moves to block 660, and the content server 142 determines if the content tags, advertisements, and action items should be updated. If updating is indicated, the method 600 moves to block 665, and the content service 140, in conjunction with the advertisement service 100(1) and manufacturer/service provider 160 creates new content tags, advertisements, and action items, as appropriate. If, in block 660, updating is not indicated, and following block 665, the method returns to block 620.

FIG. 8 is a flowchart illustrating an embodiment of a method for basing advertisements on the content in which the advertisements are to be displayed. In FIG. 8, method 700 is executed at the advertisement service 100(1), starting at block 705 when the advertiser generates advertisements (creatives) and associated action items in cooperation with the content service 140 and manufacturer/service provider. In block 710, the advertisement server 122(1) correlates the advertisements/action items to the content tags. In block 715, the advertisement service 100(1) receives the content tag identifications, and stores the content tag identifications, advertisements, and action items in the advertisement store 110(1). In block 720, the advertiser server 122(1) receives advertisement request instructions from the content service 140. These instruction include preparing a file to prepend to the movie, and sending a specific advertisement to the iTV 210 in response to the advertisement request. In block 725, the advertisement server 122(1) sends the advertisement and action items to the iTV 210. In block 730, the advertisement server receives an advertisement impression.

Certain of the devices shown in FIGS. 1 and 2 include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which may store data that may be accessible by the processor such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive interface for gesture or graphical input, keyboard, mouse, motion input, for example. An output device may include one or more of a number of output mechanisms. In some instances, multimodal systems enable a user to provide multiple types of input to communicate with the computing system. A communications interface generally enables the computing device system to communicate with one or more other computing devices using various communication and network protocols. To further provide for interaction with an individual, the herein disclosed embodiments may be implemented using an interactive display, such as a graphical user interface (GUI). Such GUIs may include interactive features such as pop-up or pull-down menus or lists, selection tabs, scannable features and other features that may receive human inputs.

The preceding disclosure refers to a number of flow charts and accompanying descriptions to illustrate the embodiments represented in FIGS. 5-8. The disclosed devices, components, and systems contemplate using or implementing any suitable technique for performing the steps, illustrated in these figures. Thus FIGS. 5-8 are for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein may be implemented in digital electronic circuitry, or in computer software, firmware, or hardware, including the herein disclosed structures and their equivalents. Some embodiments may be implemented as one or more computer programs, i.e., one or more modules of computer program instructions, encoded on a tangible computer storage medium for execution by one or more processors. A computer storage medium may be, or may be included in, a computer-readable storage device, a computer-readable storage substrate, or a random or serial access memory. The computer storage medium may also be, or may be included in, one or more separate tangible components or media such as multiple CDs, disks, or other storage devices. The computer readable storage medium does not include a signal.

As used herein, the term processor encompasses all kinds of apparatus, devices, and machines for processing data including by way of example a programmable processor, a computer, a system on a chip, or multiple ones, or combinations of the foregoing. The processor may include special purpose logic circuitry, e.g., an FPGA (field programmable gate array) or an ASIC (application-specific integrated circuit). The processor also may include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) may be written in any form of programming language, including compiled or interpreted languages, declarative or procedural languages, and the program may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple, computers that are located at one site or distributed across multiple sites and interconnected by a communication network.

The computing system disclosed herein may include clients and servers. A client and server may be remote from each other and typically interact through a communications network. The relationship of client and server arises by virtue of computer programs running on the respective computers and having a client-server relationship to each other. In some embodiments a server transmits data (e.g., an HTML page) to a client device (e.g., for purposes of displaying data to and receiving user input from a user interacting with the client device). Data generated at the client device (e.g., a result of the user interaction) may, be received from the client device at the server.

1. A method for providing advertisements relevant to media displayable on a first electronic media display device, the media including one or more content tags, the method, comprising:
receiving a signal originating from the first electronic media display device indicating detection of a content tag, wherein media comprising the one or more content tags is displayed on the first electronic media display device;
serving an advertisement to the first electronic media display device, wherein the advertisement is selected based on the received content tag detection signal;
serving one or more selectable action items associated with the selected advertisement to the first electronic media display device;
receiving, from a second electronic media display device, an action item selection from the one or more selectable action items; and
responding to the action item selection.

2. The method of claim 1, wherein the first electronic media display device is in communication with the second electronic media display device, the method further comprising:
serving the action items to the second electronic media display device.

3. The method of claim 2, further comprising serving the advertisement to the second electronic media display device.

4. The method of claim 3, further comprising serving the advertisement to the first electronic media display device for display of the advertisement during a display of the media on the first electronic display device.

5. A method for providing advertisements relevant to media displayable on a first electronic media display device, the first electronic media display device in communication with a second electronic media display device, the media including one or more content tags, the method, comprising:
receiving a signal originating from the first electronic media display device indicating detection of a content tag, wherein media comprising the one or more content tags is displayed on the first electronic media display device;
serving an advertisement to the first electronic media display device, wherein the advertisement is selected based on the received content tag detection signal;
serving one or more selectable action items associated with the selected advertisement to the first electronic media display device;
receiving an action item selection from the second electronic media display device, wherein the second electronic media display device receives the one or more selectable action items from the first electronic media display device; and
responding to the action item selection.

6. The method of claim 1, wherein the content tag defines an advertisement opportunity in the displayable media.

7. The method of claim 6, further comprising receiving a time stamp with the signal, the time stamp indicating a start time of the advertising opportunity.

8. The method of claim 7, wherein the content tag is provided in the media at a time preceding a start time of the advertising opportunity.

9. The method of claim 1, further comprising providing advertisements in a file prepended to the media.

10. The method of claim 9, further comprising overriding an advertisement in the prepended file by displaying the selected advertisement on the first electronic media display device.

11. The method of claim 1, further comprising correlating the advertisement and the content tag.

12. An advertising method in which advertisements are provided for display on a first media display device based on content displayed on the first media display device, comprising:
receiving a content file for display on the first media display device, the content file including one or more content tags;
detecting a content tag during display of the content;
decoding the content tag to extract content metadata associated with the content;
sending the content metadata to a content service as an advertisement request; and
receiving and displaying an advertisement on the media display device;
receiving one or more action items associated with the received advertisement; and
sending, by the first media display device, the received one or more action items to a second media display device.

13. The method of claim 12, further comprising:
selecting, at the second media display device an action item from the one or more action items; and
executing, at the second media display device, the selected action item.

14. The method of claim 13, further comprising:
displaying the action items in an action item interface of the second media display device.

15. The method of claim 14, wherein the first media display device is an intelligent, Internet-connected television (iTV) and the second media display device is a tablet.

16. The method of claim 12, wherein the content tags identify advertising opportunities in the content, the method further comprising:
providing a time stamp indicative of a start time of an advertising opportunity; and
displaying the advertisement at the start time of the advertising opportunity.

17. The method of claim 12, further comprising:
receiving one or more advertisements in a file prepended to the content;
storing the prepended file in the first media display device; and
selecting one of the advertisements from the prepended file for display on the first media display device in response to detection of the content tag.

18. A computer readable storage medium encoded with a computer program, the program comprising instructions that, when executed by a processor, causes the processor to:
receive and process a signal originating from a first electronic media display device indicating detection of a content tag embedded in media displayed on the first electronic media display device;
select an advertisement and one or more action items associated with the advertisement based on the received and processed content tag detection signal;
serve the selected advertisement and the one or more selected action items to the first electronic media display device; and
receive an action item selection from a second electronic media display device in communication with the first electronic media display device.

19. The computer readable storage medium of claim 18, wherein the processor:
provides a response to the first electronic media display device based on the selected action item.

20. A computer readable storage medium encoded with a computer program, the program comprising instructions that, when executed by a processor, causes the processor to:
receive a content file for display on a media display device, the content file including one or more content tags;
detect a content tag during display of the content;
decode the content tag to extract content metadata associated with the content;
send the content metadata to a content service as an advertisement request;
receive and display an advertisement on the media display device;
receive and display one or more selected action items to the first electronic media display device; and
receive an action item selection from a second electronic media display device in communication with the first electronic media display device.
